(19) United States
(12) Patent Application Publication
(10) Pub. No.: US 2008/0133432 A1
(43) Pub. Date: Jun. 5, 2008

(54) AUTOMATED RENTAL VEHICLE CHECK-IN SYSTEM

(76) Inventor: Robert Ramseyer, Farmington, MI (US)

Correspondence Address: GIFFORD, KRASS, SPRINKLE,ANDERSON & CITKOWSKI, P.C, PO BOX 7021, TROY, MI, 48007-7021, US

(21) Appl. No.: 12/015,114

(22) Filed: Jan. 16, 2008

Related U.S. Application Data
(63) Continuation-in-part of application No. 11/776,077, filed on Jul. 11, 2007.
Application No. 11/776,077 is a continuation-in-part of application No. 11/077,437, filed on Mar. 10, 2005.
Application No. 11/077,437 is a continuation-in-part of application No. 10/980,259, filed on Nov. 3, 2004, now abandoned.
(60) Provisional application No. 60/516,931, filed on Nov. 3, 2003.

(51) Int. Cl. G01M 17/007; G06Q 10/00

(52) U.S. Cl. 705/400; 701/32; 701/33

(57) ABSTRACT

A method of checking in a rental vehicle in a rental lot in which a handheld unit is connected to the diagnostic port for the vehicle. The handheld unit interrogates the ECU for the vehicle to determine the type of vehicle, and thus the data protocol, and, once determined, downloads and processes the data.

### CROSS REFERENCE TO RELATED APPLICATIONS

This application is a continuation-in-part of U.S. patent application Ser. No. 11/776,077 filed Jul. 11, 2007 which is a continuation-in-part of U.S. patent application Ser. No. 11/077,437 filed Mar. 10, 2005, which is a continuation-in-part of U.S. patent application Ser. No. 10/980,259 filed Nov. 3, 2004, which claims priority of U.S. Provisional Patent Application Ser. No. 60/516,931 filed Nov. 3, 2003.

### FIELD OF THE INVENTION

This invention relates to an automated check-in system for a rental vehicle and more particularly to an automated system having an information module mounted in the vehicle and connected to the electronic control units of the vehicle.

### BACKGROUND OF THE INVENTION

Rental vehicles such as cars and trucks are checked in after use and returned to a rental site. Presently, an attendant gathers rental information such as contract number from the contract, vehicle identification number from a tag on the vehicle, mileage from the odometer, and a fuel tank reading from a gauge. The attendant manually enters this information into a handheld device. The information is relayed from the handheld device by radio frequency to a remote central database which then computes the charges for the vehicle rental. The customer then proceeds to the rental office where a counter person collects the fees for the rental. In some cases, rental car companies have preexisting payment arrangements with the customer so that the rental charges are relayed back to the attendant's handheld device and a receipt is provided to the customer by the attendant. However, such systems require the attendant to enter the rental information into the handheld device. Entry into the handheld device is done by keyboard, and in many cases errors are made during the entry of the information. Accordingly, it would be advantageous to provide a device which would reduce the labor needed for vehicle check-in as well as improving the accuracy of the data provided.

There have been previously known systems in which the rental vehicle includes a transmitter which transmits the vehicle identification information and other pertinent data either upon entry into the rental lot, or when interrogated by a transmitter at the rental lot. These previous systems, however, are expensive and require installation into each rental vehicle. Furthermore, these systems are customized depending upon the type and make of the vehicle. For example, a transmitter that is operational for a Ford vehicle would not be operational for a General Motors vehicle or other type of vehicle. This, in turn, required that large inventories of different transmitters be maintained in order to accommodate the different types of rental vehicles.

### SUMMARY OF THE INVENTION

It is therefore an object of the invention to provide an automated system for checking in rental cars to a rental lot. The system includes an information module which is mounted to the rental vehicle. The information module has an information gathering device for gathering electronic information from the vehicle data bus. The information includes vehicle identification number, mileage and fuel level. The information module may be connected to the diagnostic port of the vehicle. A processor and information interface in the module obtain the needed information from the vehicle and deliver it by wireless device to a receiving station. Once the vehicle is on the premises of the lot, the activation device initiates the sending module to transmit the information. The information module sends information to the receiving station which delivers the information to a CPU which has a database containing files which obtain rental information and pricing information. The CPU calculates the charges for the rental vehicle based on information gathered from the information unit and produces a rental charge. A receipt may be provided to the customer at a kiosk located at the rental lot.

In a further improvement, a handheld portable unit is physically connected to the United States required diagnostic port to download the data from the vehicle. Upon connection, the portable unit interrogates the vehicle electronic control unit to determine the type or make of the vehicle and, once determined, downloads the appropriate information from the vehicle. Rental charges are then calculated from the data and, upon payment, a receipt is optionally printed by the portable unit.

### BRIEF DESCRIPTION OF THE DRAWING

A better understanding of the present invention will now be had in reference to the accompanying drawing wherein like reference characters refer to like parts throughout the several views herein in which:

FIG. 1 is a schematic diagram showing a check-in system in accordance with the invention;

FIG. 2 is a schematic view of a sending module connected to a vehicle in accordance with the invention;

FIG. 3 is a block diagram showing the method in accordance with the invention;

FIG. 4 is a block diagrammatic view illustrating a modification to the invention;

FIG. 5 is a flowchart illustrating the operation of the present invention; and

FIG. 6 is a planar view illustrating a modification of the invention.

### DETAILED DESCRIPTION OF THE INVENTION

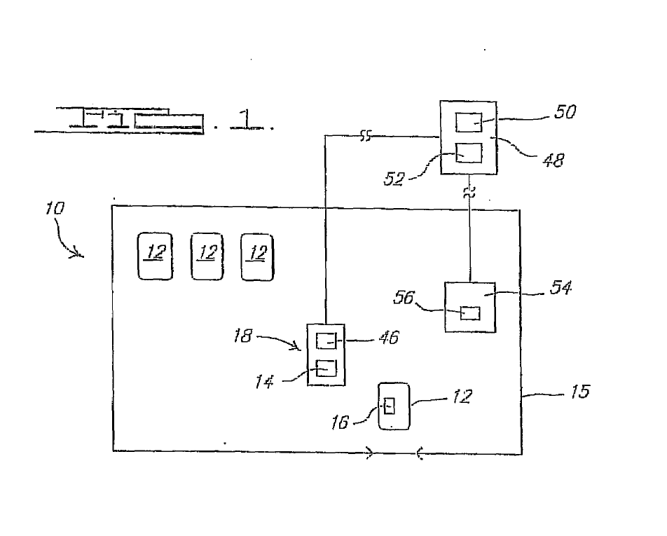

A fully automated check-in system 10 for a rental vehicle 12 is shown in FIG. 1. The system includes an activation device 14 positioned in or about a rental lot 15. The activation device 14 initiates an information module 16 which is mounted to the vehicle 12. The sending module transmits information to a receiving device 18 which is connected to a CPU 48 for checking in the vehicle 12.

The activation device 14 may be of any type device which activates the module when the vehicle enters the return lot 16 of the rental car operation. The activation device may be a two-way radio and incorporated into the receiving station 18. However, other types of devices such as magnetic strips which interact with a magnetic switch in the information module 16 may be used. Alternatively the activation device can be mounted directly in the vehicle in the form of a GPS unit which is programmed to activate the information module 16 when the vehicle 12 enters into the return lot 15. The locations of the return lots are programmed into the GPS unit as waypoints. When the GPS unit recognizes one of the waypoints, a signal is sent to activate the information unit.

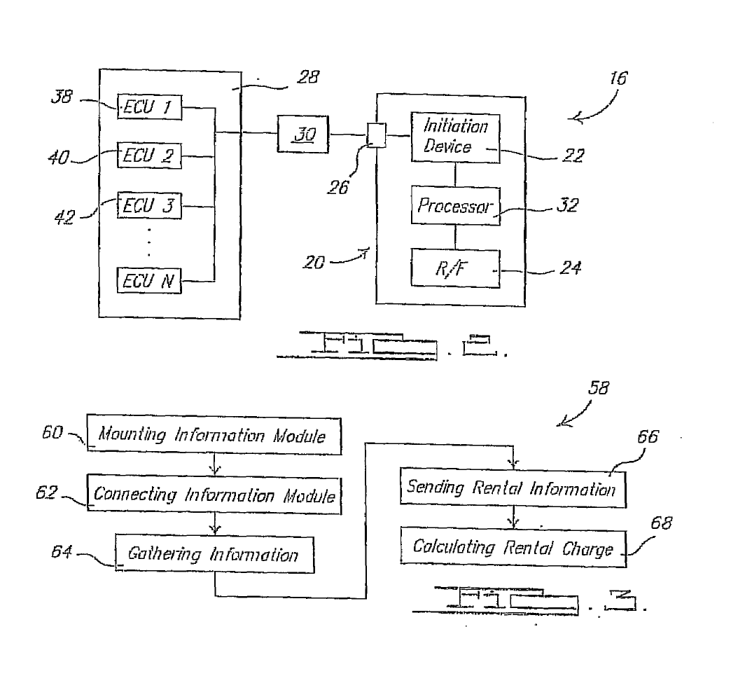

As best shown in FIG. 2, the information module 16 is a compact device which is fixedly mounted to the vehicle. The information module 16 has a housing 20 which holds an initiation device 22, an information gathering device or processor 32, and a wireless transmission device 24. The module 16 has a connector 26 for connection to a conventional data bus 28 which is provided in vehicles. The bus 28 carries electronic information signals from the sensors and electrical components of the vehicle 12. In the preferred embodiment, the information module 16 is connected directly to electronic control units of the vehicle 12. The diagnostic port 30 is a federally mandated port which permits access to the information contained within the vehicle 12.

The information gathering device 22 includes a processor 32 and interface 34 which directs the processor 32 to gather rental information from the data bus 28. This information includes vehicle identification number 38, fuel level 40, and vehicle mileage 42. If desired, diagnostic information 44 can be obtained for updating service records and vehicle maintenance at the same time. The processor then activates the transmission device 24 to transmit the rental information 36 obtained wirelessly by using a Bluetooth or 802.11 protocol to the receiving station 18.

The receiving station IS has a radio receiver 46 which receives the information from the information unit. The receiving station is located in the rental lot 16. The receiver 16 is connected to a CPU 48. The CPU may be located at the rental lot or a remote location and includes a database 50 with files 52 having rental information for the vehicle 12. When the CPU 48 receives return information from the receiver, the location of the rental lot and a timestamp are entered into the file. The CPU then utilizes the rental information from the vehicle to calculate the charges for the rental. Any maintenance problem such as oil life, low tire pressure, or potential maintenance problems as identified by the diagnostic trouble codes are relayed to the vehicle maintenance department for attention by the maintenance staff.

The charges for the rental are then delivered to a kiosk 54 located in the rental lot 16 where the customer is prompted to pay the charges which are displayed on a screen. The customer may use a credit card, debit card or the like to pay the charge. In many instances, the customer may have a previous agreement or account with the rental company such that it is not necessary to pay the charges at the time. A receipt from the printer of the kiosk by an attendant with a mobile printer is then delivered to the customer or may be separately mailed or emailed to the customer.

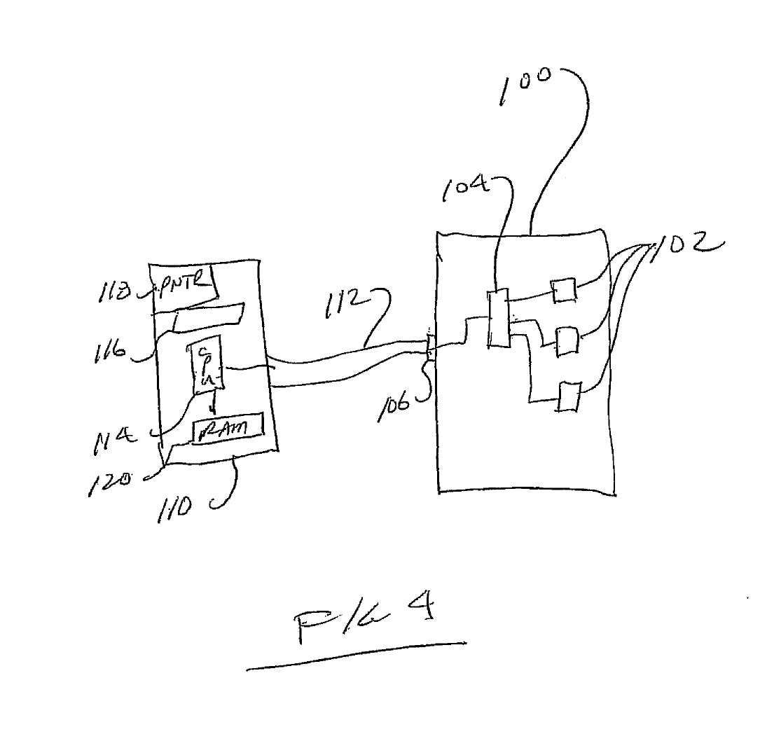

As shown in FIG. 3, the method 58 in accordance with the invention includes the steps of mounting 60 an information module in a vehicle, connecting 62 the module to the data bus of the vehicle gathering 64 rental information from the data bus, sending rental information taken from the data bus to a remote station and calculating 68 the rental charge for the vehicle using the rental information sent from the information module. Additionally, the system includes charging the customer for the rental and providing a receipt.

Thus is provided a fully automated and inexpensive information retrieval and delivery system for rental vehicles. The system permits the elimination of check-in attendants and ensures the accuracy of the delivery of information. The speed of rental check-in is increased and vehicle maintenance problems are reduced by obtaining accurate information on such things as oil level, tire pressure and contained in diagnostic trouble codes.

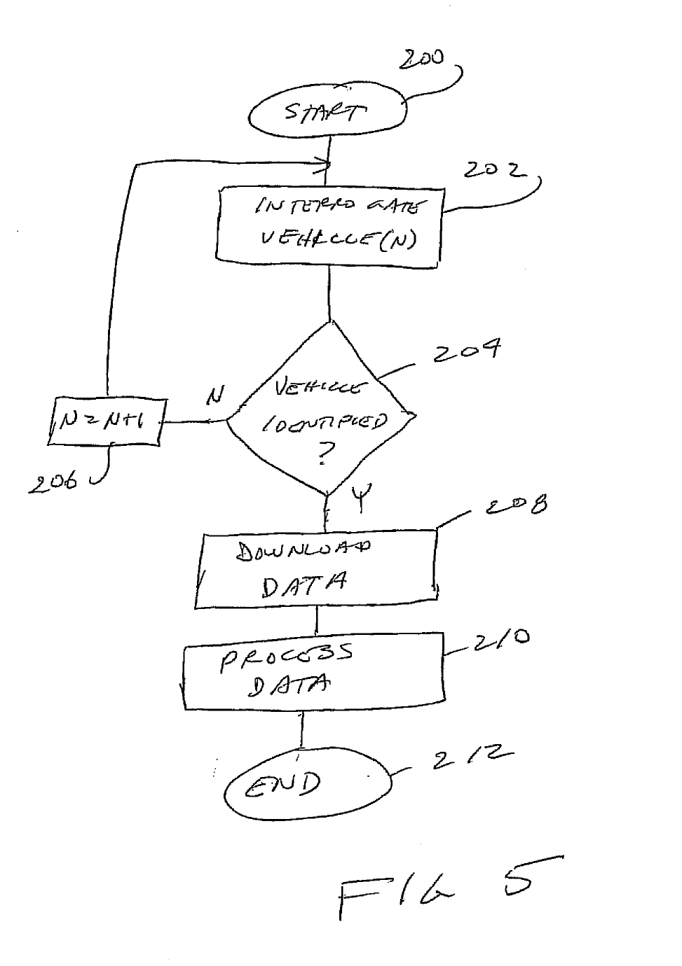

With reference now to FIG. 4, a modification of the present invention is illustrated for use with a vehicle 100, illustrated diagrammatically. The vehicle 100 includes a plurality of sensors 102 which measure, for example, fuel level, odometer and optionally other data. The data from the sensors 102 is coupled to a central processing unit 104 contained in the vehicle 100.

The central processing unit 104 is coupled to a diagnostic port 106. This diagnostic port 106 is currently mandated by the United States government for all new vehicles sold in the United States. The diagnostic port 106 is oftentimes located in the passenger compartment and provides a means for accessing the central processing unit 104 and any data that is maintained by the processor 104. Such data includes the sensor readings from the sensors 102.

Upon return of the rental car to the rental lot, a handheld unit 110 is physically connected to the diagnostic port 106. After connection of the handheld portable unit 110 to the diagnostic port 106, the handheld unit 110 includes a programmed central processing unit 114 which initially interrogates the vehicle 100 to determine the type or make of the vehicle. After the vehicle is identified, the handheld unit 110 downloads the sensor data from the processor 104 through the diagnostic port 106. While downloading the sensor data, or immediately after downloading the sensor data, a transmitter 109 in the handheld unit 110 transmits the sensor data under control of a processor 111 to a remote central station 112. The main system 112 then calculates the appropriate rental charges for the vehicle 100 and then produces an output signal representative of those rental charges.

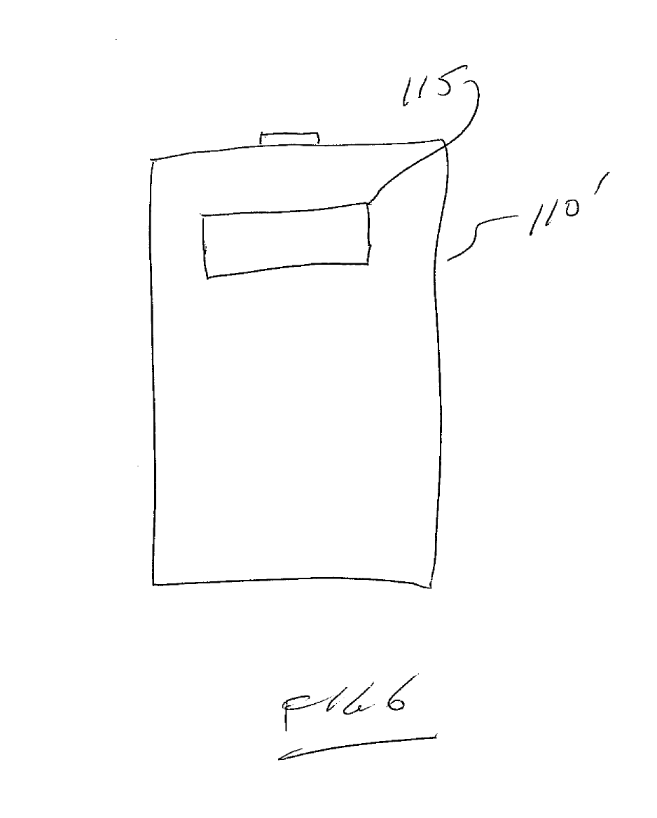

With reference to FIG. 5 an exemplary flowchart is shown illustrating the operation of the present invention. After the handheld unit is attached to the diagnostic port at step 200, the algorithm proceeds to step 202.

At step 202 the vehicle electronic control unit (ECU) is interrogated to determine if it is a vehicle of type N where N represents a list of different types of vehicles. Step 202 then proceeds to step 204.

At step 204 the program determines if the vehicle is identified. Such identification could be determined if a proper vehicle identification number WIN) was received by the handheld unit. If the vehicle is not identified, step 204 branches to step 206 where N is incremented to the next type of vehicle in the list. Step 206 then branches back to step 202 and steps 202-206 are reiterated until the type of vehicle has been identified.

Once the vehicle is identified, and thus the data protocol for the ECU determined, step 204 branches to step 208 where the data is downloaded from the vehicle to the handheld unit through the diagnostic port 106. Such data includes the VIN, fuel level, odometer and, optionally, any maintenance codes that have been set. Step 208 then proceeds to step 210 where the data is processed by wirelessly transmitting the sensor data to the central station 112 to calculate and output the rental charge. The program then terminates at step 212. Such processing, furthermore, may optionally be performed by the handheld unit, but preferably the handheld unit may transmits the data to a central station 112 at the rental lot.

A primary advantage of the present invention is that the handheld unit may be used for different types of vehicles even though the different vehicles use different data protocols.

Although the present invention has been described for use as a system for checking in rental cars at a rental lot, it will be understood that the invention may be used whenever tracking of automotive vehicles is required. For example, automotive dealers, automotive repair shops and the like may likewise use the present invention to track automotive vehicles.

In this event, when the automotive vehicle is checked into the automotive dealer or repair shop, the handheld portable unit is connected to the diagnostic port of the vehicle. The handheld unit then interrogates the vehicle to identify the vehicle type and, once identified, downloads the vehicle data through the diagnostic port according to the data protocol for that particular vehicle.

With reference to FIG. 6, a modified handheld unit 110′ is illustrated for use by automotive dealers and repair facilities. The handheld unit 110′ differs from the handheld unit 110 shown in FIG. 4 in that the handheld unit 110′ includes a display device 115, such as an LCD which displays the vehicle VIN which is then noted by the operator. In this fashion, the handheld unit 110′ may be used to track vehicles as they enter and leave the dealership or repair facility. Optionally, the handheld unit transmits the VIN to a central station.

While the present invention has been described in its preferred forms with a certain degree of particularity, it is understood that the present disclosure of the several preferred embodiments has been by way of example and that numerous changes to the detailed construction, combination and arrangement of the elements may be resorted to without departing from the spirit and scope of the invention as hereinafter claimed.

We claim:

1. A method of checking in a rental vehicle having a diagnostic port at a return lot comprising the steps of:
connecting a handheld portable unit to the diagnostic port,
interrogating the vehicle through the diagnostic port to determine the vehicle type,
thereafter downloading vehicle data from the vehicle to the portable unit through the diagnostic port,
calculating a rental charge for the vehicle from the downloaded data,
outputting the rental charge.

2. The invention as defined in claim 1 wherein the outputting step comprises printing a receipt by the portable unit.

3. The invention as defined in claim 1 wherein the outputting step comprises displaying the rental charge on a video display.

4. The invention as defined in claim 3 wherein the video display comprises an LCD display.

5. The invention as defined in claim 1 and comprising the step of transmitting the sensor data to a remote central station prior to said calculating and outputting steps.

6. A method of identifying a vehicle having a diagnostic port comprising the steps of:
connecting a handheld portable unit to the diagnostic port,
interrogating the vehicle through the diagnostic port to determine the vehicle type,
thereafter downloading vehicle data from the vehicle to the portable unit through the diagnostic port,
thereafter displaying the downloaded vehicle data.

7. The invention as defined in claim 6 wherein said displaying step comprises the step of displaying said data on said handheld portable unit.

8. A method of checking in a vehicle having a diagnostic port at a vehicle service facility comprising the steps of:
connecting a handheld portable unit to the diagnostic port,
interrogating the vehicle through the diagnostic port to determine the vehicle type,
thereafter downloading vehicle data from the vehicle to the portable unit through the diagnostic port,
thereafter transferring the vehicle data to a remote station,
whereby the remote station uses the vehicle data to initiate a service transaction record.

9. The invention as defined in claim 8 wherein the vehicle data contains at least the vehicle identification number and the odometer value.

10. The invention as defined in claim 8 wherein the vehicle data contains diagnostic trouble codes.

11. The invention in claim 8 wherein the remote station provides access to the business management software for the service facility.

12. A method of automated vehicle history retrieval for a vehicle having a diagnostic port at a vehicle service facility comprising the steps of:
connecting a handheld portable unit to the diagnostic port,
interrogating the vehicle through the diagnostic port to determine the vehicle type,
thereafter downloading vehicle data from the vehicle to the portable unit through the diagnostic port,
thereafter transferring the vehicle data to a remote station,
whereby the remote station uses the vehicle data to initiate a search on vehicle history.

13. The invention as defined in claim 12 wherein vehicle data includes at least the vehicle identification number and the odometer value.

14. The invention as defined in claim 12 wherein the vehicle data contains diagnostic trouble codes.

15. The invention as defined in claim 12 wherein vehicle history includes repair history, recall information, warranty information, service contract information, and option content.

16. The invention as defined in claim 12 wherein the vehicle history is automatically printed after being retrieved.

17. A method of checking in a vehicle having a Bluetooth-enabled connection to the diagnostic data bus at a service facility comprising the steps of:
establishing a connection between the vehicle's Bluetooth adapter and an external Bluetooth unit,
thereafter the external unit commands the vehicle to establish a diagnostic session via the Bluetooth connection,
downloading vehicle data from the diagnostic data bus to the external unit through the Bluetooth connection,
transferring the data to a remote station,
whereby the remote station uses the vehicle data to initiate a service transaction record.

18. The invention as defined in claim 17 wherein the vehicle data contains at least the vehicle identification number and odometer value.

19. The invention as defined in claim 17 wherein the vehicle data contains diagnostic trouble codes.

20. The invention in claim 17 wherein the remote station provides access to the business management software for the service facility.

21. A method of automated vehicle history retrieval for a vehicle having a Bluetooth-enabled connection to the diagnostic data bus at a service facility comprising the steps of:
establishing a connection between the vehicle's Bluetooth adapter and an external Bluetooth unit,
thereafter the external unit commands the vehicle to establish a diagnostic session,
downloading vehicle data from the diagnostic data bus to the external unit through the Bluetooth connection,
transferring the data to a remote station,
whereby the remote station uses the vehicle data to initiate a search on vehicle history.

22. The invention as defined in claim 21 wherein vehicle data includes at least the vehicle identification number and the odometer value.

23. The invention as defined in claim 21 wherein the vehicle data contains diagnostic trouble codes.

24. The invention as defined in claim 21 wherein vehicle history includes repair history, recall information, warranty information, service contract information, and option content.

25. The invention as defined in claim 21 wherein the vehicle history is automatically printed after being retrieved.
